(19) United States
(12) Patent Application Publication
(10) Pub. No.: US 2013/0273260 A1
(43) Pub. Date: Oct. 17, 2013

(54) METHOD FOR MANUFACTURING GRAPHERE LAYER BY LASER

(71) Applicant: NATIONAL TSING HUA UNIVERSITY, Hsinchu (TW)

(72) Inventors: Yu-Lun CHUEH, Hsinchu (TW); Ji-Jia DING, Hsinchu (TW); Hung-Chiao LIN, Hsinchu (TW); Yu-Hsiang HUANG, Hsinchu (TW)

(21) Appl. No.: 13/861,148

(22) Filed: Apr. 11, 2013

(30) Foreign Application Priority Data
Apr. 12, 2012 (TW) 101112990

(51) Int. Cl. C01B 31/04

(52) U.S. Cl. CPC C01B 31/0446
USPC 427/555; 427/554

(57) ABSTRACT

The present invention relates to a method for manufacturing a graphene layer, comprising the following steps: providing a substrate; forming a metal layer on a first side of the substrate; forming a carbon source layer on the metal layer; providing a laser, which irradiates a second side of the substrate and passes through the substrate to form a graphene layer on an interface between the substrate and the metal layer; and providing an organic solvent and an acid solution to remove the carbon source layer and the metal layer respectively.

### CROSS REFERENCE TO RELATED APPLICATION

This application claims the benefits of the Taiwan Patent Application Serial Number 101112990, filed on Apr. 12, 2012, the subject matter of which is incorporated herein by reference.

### BACKGROUND OF THE INVENTION

1. Field of the Invention

The present invention relates to a method for manufacturing a graphene layer and, more particularly, to a method for manufacturing a transparent graphene layer array with high density induced by using a laser.

2. Description of Related Art

As the photoelectric display technology shows more signs of progress, transparent electrode has been proven to be an instrumental part for many of its related disciplines, including light-emitting diodes (LED), flat panel displays (FPD), touch screens and dye-sensitized solar cells (DSSC). Currently, ITO or tin-doped indium oxide is the major material for transparent conductive electrode. The majority of transparent electrodes are currently made from ITO, or tin-doped indium oxide. Even though the use of ITO as an optoelectronic element may appear to be well-known and well-received in the general arts, there are still some related shortcomings that may hinder its prospective progress, for example the fact that the scarcity of indium in the Earth's crust invariably means higher economic cost, and the instability of indium tin oxide exhibited under acidic or alkaline environments presents another issue calling for solutions.

The two-dimensional structure of graphene and its exceptional physical attributes have received popular attention for some time. With the thinnest thickness and the hardest physical properties, graphene almost appears transparence. Indeed, graphene is the thinnest and also the hardest known material with special properties stemming from its nano-scale dimension. Since graphene has the characters of high conductivity (its sheet resistance can reach 100 Ω/sq), transmittance (which can reach 90%) and high yield production, graphene can be appropriately regarded as a replacement for transparent conductor ITO. Therefore, graphene has been a potential optoelectronic material to substitute for ITO. As such, graphene is considered a serious contender as an alternative to indium-tin-oxide for an emerging optoelectronic material.

Graphene can be obtained by several different approaches, for example, mechanical peeling method, epitaxial growth, chemical vapor deposition (CVD) and slicing carbon nanotubes. However, the above-mentioned methods still have their disadvantages, such as the size of graphene, which is difficult to be controlled by mechanical peeling method. Furthermore, the graphene prepared by mechanical peeling method may crack easily. In addition, the disadvantages of manufacturing graphene by CVD are high operating temperature, time-consuming, and complicated transferring procedures.

Accordingly, it is desirable to provide a simple method for manufacturing a graphene layer on a target substrate without performing a traditional transferring process, so as not to only reduce production time and cost but also increase production volume.

### SUMMARY OF THE INVENTION

The object of the present invention is to provide a method for manufacturing a graphene layer by using a laser. Except for general transferring process, the present invention provides a simple method for fabricating a high-density transparent graphene layer without performing transferring process, and the obtained graphene layer can be utilized as a transparent electrode layer in optoelectronic devices.

To achieve the above object, the present invention provides a method for manufacturing a graphene layer, comprising the following steps: providing a substrate; forming a metal layer on a first side of the substrate; forming a carbon source layer on the metal layer; providing a laser, which irradiates a second side of the substrate and passes through the substrate to form a graphene layer between an interface of the substrate and the metal layer; and providing an organic solvent and an acid solution to remove the carbon source layer and the metal layer respectively.

In the above steps, the metal layer has higher laser energy absorbance ratio than the substrate; therefore, the metal layer can effectively use the absorbed energy to raise its temperature so as to absorb the carbon atoms of the substrate layer containing carbon source, which can be extruded from the carbon source layer and fused into the metal layer to form graphene from the cooling-down of the substrate when the laser source tilts away. Finally, with the exception of the graphene layer between the metal layer and the substrate, the remaining portion can be instantly removed, wherein the carbon source layer can be removed by the organic solvent, and the metal layer can be removed by the acid solution. Therefore, in view of the present invention, the graphene can be formed on the substrate within a few minutes in a fast fabrication way, and the graphene obtained from such method can be attached directly onto the substrate, saving time for a general transferring process.

In with the present invention, the substrate may be a transparent substrate, such as a glass substrate, a plastic substrate or a quartz substrate, among which the glass substrate is preferable. The laser can irradiate from the second side of the substrate and pass through the substrate to the metal layer on the first side of the substrate to leverage on the high transparency of the substrate.

In the method of the present invention, the metal layer can be a nickel layer or a rhodium layer, which can be used as a catalytic layer to be irradiated and heated by the laser, and as a carbon-atom-inducing-layer to form a graphene layer on it. A thickness of the metal layer may be 10-300 nm, and preferably 100 nm. When the thickness of the metal layer is less than 10 nm, the resulting graphene layer would not be able to precipitate into graphene; on the other hand, when the thickness of the metal layer is more than 300 nm, the metal layer may easily curl and separate from the substrate due to insufficient adhesion bonding between the metal layer and the substrate.

Additionally, the method of the present invention may further comprise a step of patterning the metal layer; therefore, the graphene layer with a pattern corresponding to the patterned metal layer can be formed when laser irradiate. Hence, the present invention provides a solution to form a patterned graphene layer without the need to go through a transferring process, such configuration can significant keep down the cost required for a transferring process, and can avoid cracking of the graphene in a transferring process.

In the method of the present invention, the carbon source layer is a solid state carbon source layer, in which a material of the carbon source layer can be polymethyl methacrylate (PMMA) or polydimethylsiloxane (PDMS). A thickness of the carbon source layer may be 100-2000 nm, and preferably 1000 nm or more. When the thickness of the carbon source layer is less than 100 nm, the carbon source layer cannot be formed uniformly atop the metal layer so as to induce non-uniform graphene layer. On the other hand, when the thickness of the carbon source layer exceeds the 2000 nm threshold, the additionally carbon source would become a waste and the time for removing the carbon source layer may be extended.

In the method of the present invention, the laser can be an infrared laser or a visible laser. In essence, an aspect of the present invention aims to turn the preciseness of the laser technique, its single wavelength, and higher energy concentration to increase the metal layer's temperature through rapid heating of a metal layer covering a portion of the substrate, and consequently encourage the surrounding carbon atoms to fuse into the metal layer, so that upon a cooling-down step, the carbon atom can be extruded from the metal layer surface to precipitate into graphene.

Additionally, a laser wavelength can be 200-2000 nm, preferably 532 nm The emitted energy per unit area of the laser can be 100 mW/cm²−5 W/cm², preferably 2 W/cm². When the wavelength of the laser is infrared or the emitted energy per unit area of the laser is less than 100 mW/cm², no graphene will be precipitated as the metal layer cannot absorb sufficient energy; on the contrary, when the emitted energy per unit area of the laser is more than 5 W/cm², the metal layer and the substrate may be damaged due to excessive absorbance of energy. Besides, laser irradiation time can be within 0.1-10 minutes, preferably 6 minutes.

In the method of the present invention, the organic solvent can be acetone, benzene, chloroform, methyl ethyl ketone (MEK), tetrahydrofuran (THF), chclohexanone or methylene chloride, preferably acetone. After a fabrication of the graphene layer is accomplished, the organic solvent can remove the excess carbon source layer.

In the method of the present invention, the acid solution can be dilute hydrochloric acid or acetic acid, preferably dilute hydrochloric acid, which can remove the metal layer.

As a result, the purpose of the present invention is to manufacture a graphene layer by irradiating and heating locally the metal layer with a laser, and then cooling the substrate rapidly to form graphene. Beside, the metal layer and the carbon source layer can be removed directly by the organic solvent and the acid solution. Therefore, according to the method of the present invention, a manufacturing cost and a transferring time of the graphene can be effectively improved, so as to achieve the advantages of fast and simple manufacture process, and mass production. For this reason, the utility of the graphene layer manufactured by the present invention can be substantially improved and increased in the field of optoelectronic industry.

Other objects, advantages, and novel features of the invention will become more apparent from the following detailed description when taken in conjunction with the accompanying drawings.

### BRIEF DESCRIPTION OF THE DRAWINGS

FIG. 1A to 1E illustrate schematic cross-section views for manufacturing a graphene layer according to Example 1 of the present invention;

FIG. 2A to 2B illustrate schematic cross-section views for manufacturing a graphene layer according to Example 2 of the present invention;

FIG. 3A to 3D illustrate schematic cross-section views for manufacturing a graphene layer according to Example 3 of the present invention;

FIG. 4 is an optical microscopy (OM) observation view of a graphene layer according to Example 4 to Example 7, wherein (A) is the observation view of Example 4, (B) is the observation view of Example 5, (C) is the observation view of Example 6 and (D) is the observation view of Example 7;

FIG. 5 is a result of RAMAN spectrum of the graphene layers according to Example 4 to Example 7; and

FIG. 6 is a result of transmission spectrum of the graphene layers according to Example 4 to Example 7.

### DETAILED DESCRIPTION OF THE PREFERRED EMBODIMENT

In the following description, numerous specific details are set forth to provide a thorough understanding of embodiments of the present disclosure. However, one having an ordinary skill in the art will recognize that embodiments of the disclosure can be practiced without these specific details. In some instances, well-known structures and processes are not described in detail to avoid unnecessarily obscuring embodiments of the present disclosure.

### EXAMPLE 1

Fabrication of Non-Patterned Graphene Layer.

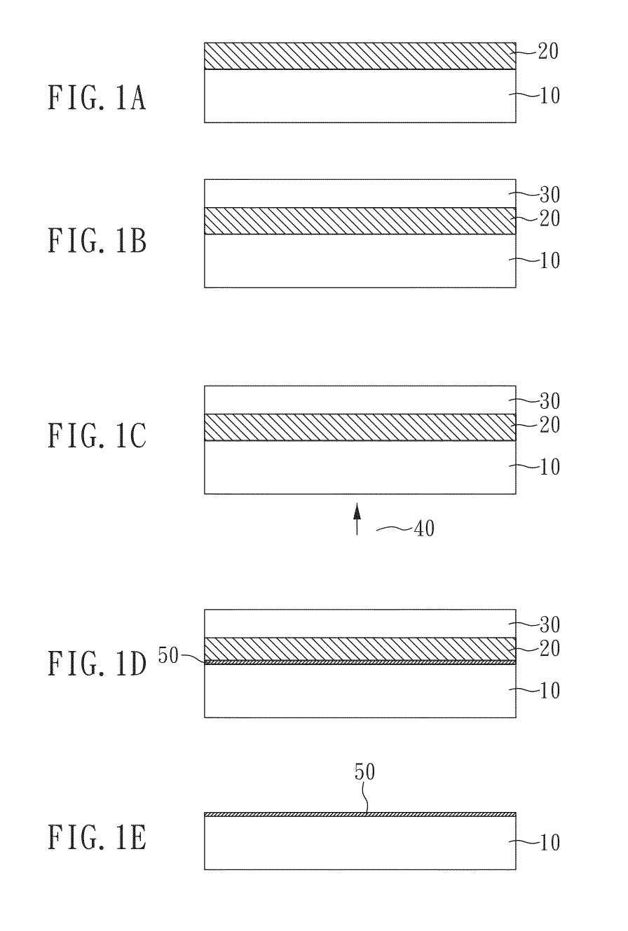

First, as shown in FIG. 1A, a substrate 10 is provided. In this example, the substrate 10 is a transparent glass substrate, and a metal layer 20 is formed on a first side 101 of the substrate 10 through evaporation at a condition of 1'10⁻⁵ torr (degree of vacuum) and 0.5 Å/s (evaporation rate). The metal layer is a nickel layer with 100 nm in thickness.

Then, as shown in FIG. 1B, a carbon source layer 30 is coated on the metal layer 20 at a spin coating rate of 3000 rpm to form a specimen of glass/nickel/PMMA, so as to fabricate a graphene layer. In this example, a material of the carbon source layer is polymethyl methacrylate (PMMA) with 1000 nm in thickness.

Next, as shown in FIG. 1C, a laser 40 is provided, in which the laser 40 is an infrared laser with a wavelength of 808 nm The laser 40 (2 W/cm²) irradiates a second side 102 of the substrate 10 and passes through the substrate 10 on an interface of the substrate 10 and the metal layer (nickel layer) 20 for 6 minutes. Due to different laser energy absorption ratios of the glass substrate 10 (<5%), the nickel layer 20 (≈30%) and the carbon source layer (PMMA) (<3%), the temperature of the nickel layer 20 can be effectively raised by absorbing laser energy, and carbon atoms from the carbon source layer 30 can be fused into the metal layer 20. After the laser 40 rapidly removed from the metal layer 20, the temperature of the metal layer 20 is then decreased so as to form a graphene layer on the interface between the substrate 10 and the metal layer 20 (as shown in FIG. 1D).

Finally, an organic solvent is provided to remove the excess carbon source layer 30, and an acid solution is provided to wash away the metal layer 20, in which the organic solvent is acetone and the acid solution is diluted hydrochloric acid. As shown in FIG. 1E, the graphene layer 50 is formed on the substrate 10 after removing the metal layer 20 and the excess carbon source layer 30 without performing a transferring process. Therefore, the graphene layer can be formed on the substrate without the need for a traditional transferring process in this example, and the obtained graphene layer can be used directly as a transparent electrode in optoelectronic devices.

### EXAMPLE 2

Forming a Patterned Graphene Layer by Controlling a Radiation Area of Laser.

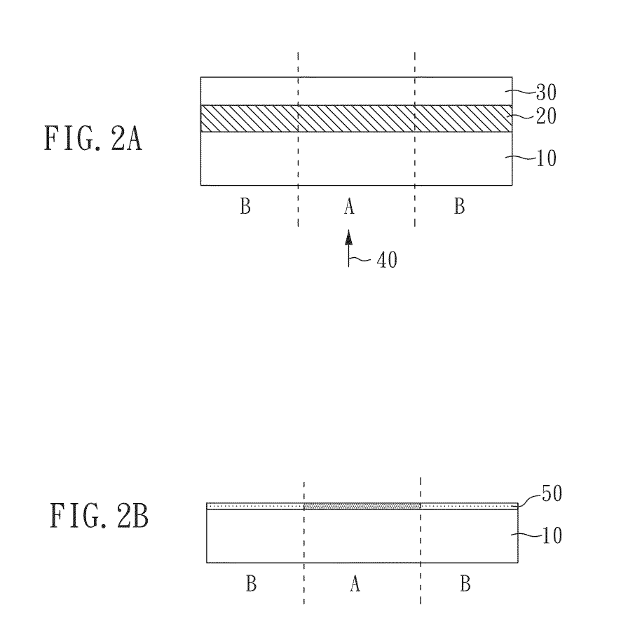

The materials and the manufacturing method of the present example are the same as Example 1, except for an irradiation region of the substrate 10 irradiated by the laser 40. In FIG. 2A, the region A represents radiation area and the region B represents non-radiation region. In general, metal material has excellent thermal conductivity. Therefore, when a laser irradiates on the metal layer, temperature between the radiation region and non-radiation region is merely the same, and the graphene layers formed on the radiation region A and the region B may hardly be distinguishable. However, the obtained graphene layer formed on the region A and the region B may have different properties, such as thickness, number of graphene layers and physical features. As shown in FIG. 2B, the level of graphitization, the formed structure and the physical properties of the graphene layers obtained on the radiation region and the non-radiation region are different. Consequently, graphene layers with different properties can be obtained by the method of the present example if it is necessary.

### EXAMPLE3

Forming a Patterned Graphene Layer by Patterned Metal Layer.

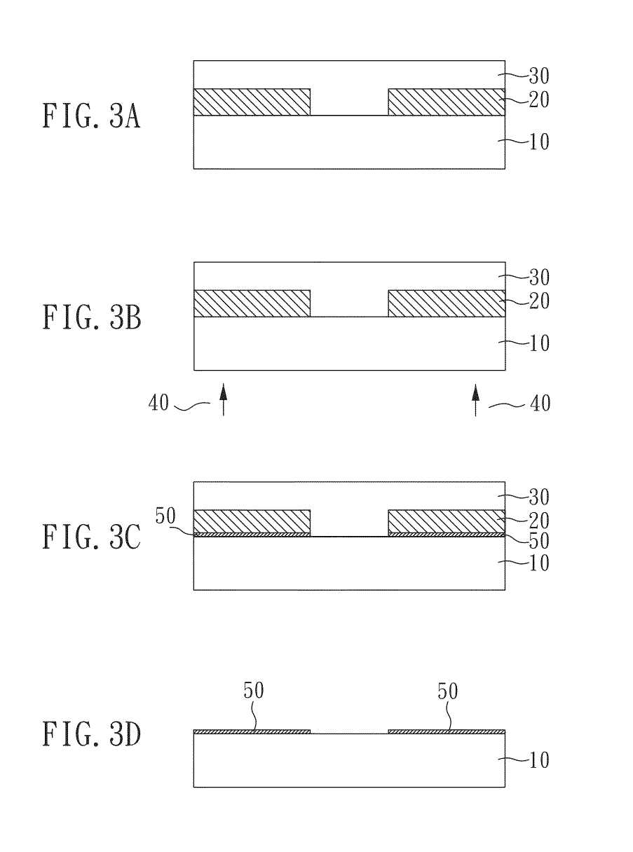

As shown in FIG. 3A, the materials and the manufacturing method are the same as Example 1, except the present example further patternizes the metal layer, which is formed on one side (the first surface 101) of the substrate 10 with a mask (not shown) by an evaporation process. After the patterned metal layer 20 is formed on the substrate 10, a carbon source is coated (spinning coating rate=3000 rpm) atop the metal layer 20 and the substrate 10, so as to obtain a structure of substrate/patterned metal layer/carbon source layer, as shown in FIG. 3B. In this example, the substrate is a glass substrate, the metal layer is a nickel layer and the carbon source layer is polymethyl methacrylate (PMMA) with a thickness of 1000 nm.

In FIG. 3, an infrared laser 40 (2 W/cm²) with a wavelength of 808 nm is provided to a second side 102 of the substrate 10 for 6 minutes. The laser light passes through the substrate to the interface between the substrate 10 and the metal layer 20, so as to form a patterned graphene layer 50 corresponding to the pattern of the patterned metal layer 20, as shown in FIG. 3C. However, a graphene layer will only be formed on a contact surface of the substrate 10 covered by a patterned metal layer 20.

After the patterned graphene layer 50 is formed on the interface between the substrate 10 and the metal layer 20, the excess carbon source layer can be removed by an organic solvent and the metal layer can be washed away by an acid solution, in which the organic solvent is acetone, and the acid solution is dilute hydrochloric acid. Finally, the substrate with the patterned graphene layer is accomplished as shown in FIG. 3D.

### EXAMPLE 4 TO EXAMPLE 7

There are a variety of parameters to control the properties of the obtained graphene layer, for example, the metal material, the method of forming a metal layer (such as evaporation, sputtering coating, or thermal annealing) and the thickness of the metal layer; the carbon source material and the thickness of the carbon source layer; type of power and radiation time; heating process performed by a laser (such as continue heating or intermittent heating); and acid wash condition (such as concentration of week acid, soaking time of the substrate in an acid solution), etc..

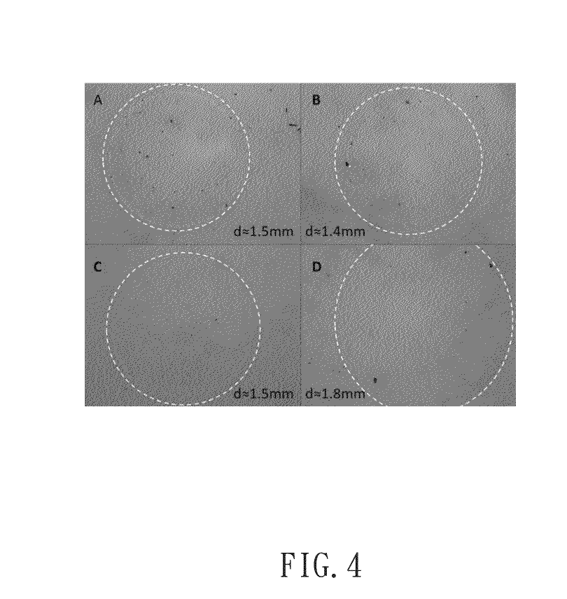

Owing to the above parameters, Example 4 to Example 7 provide different parameters to manufacture a graphene layer. The different parameters of Example 4 to Example 7 are shown as Table 1. FIG. 4 is an observation result of optical microscopy (MO) for the graphene layer manufactured by Example 4 to Example 7, in which FIG. 4(A) corresponds to the result of Example 4, FIG. 4(B) corresponds to the result of Example 5, FIG. 4(C) corresponds to the result of Example 6 and FIG. 4(D) corresponds to the result of Example 7.

TABLE 1

| | Example 4 | Example 5 | Example 6 | Example 7 |
|---|---|---|---|---|
| Thickness of | 50 | 100 | 300 | 100 |
| nickel layer | | | | (thermal |
| (nm) | | | | annealing) |
| Thickness of | 1000 | 1000 | 1000 | 1000 |
| PMMA layer | | | | |
| (nm) | | | | |
| Power of laser | 2.2 | 2.2 | 2.4 | 2.4 |
| (W/cm²) | | | | |
| Radiation time | 6 | 6 | 6 | 6 |
| (min) | | | | |
| Soaking time in | 20 | 30 | 60 | 30 |
| acid solution | | | | |
| (min) | | | | |

The graphene layers manufactured by Example 4 to Example 7 are showed by dotted circle line in FIG. 4. The graphene layers manufactured by Example 4 to Example 7 have different sizes and shapes owing to different thickness of the metal layers.

Quality of a graphene layer can be estimated by: (1) a graphitization degree, which is the ratio of signal peaks between D-region (1370 cm⁻¹) and G-region (1580 cm⁻¹), wherein the ratio of peaks between D-region and G-region can be represented as I_{D}/I_{G}, and the lower value of I_{D}/I_{G} represents the higher level of graphitization; (2) a ratio of sheet resistance, in which the smaller ratio of sheet resistance represents the higher conductive property of the graphene layer, while the graphitization degree of the graphene layer is high; (3) number of layers, in which the apparently higher signal peak of 2D-region in RAMAN spectrum represents lesser number of graphene layers; and (4) transmittance in the transmission spectrum, in which the higher transmittance represents the less number of graphene layers.

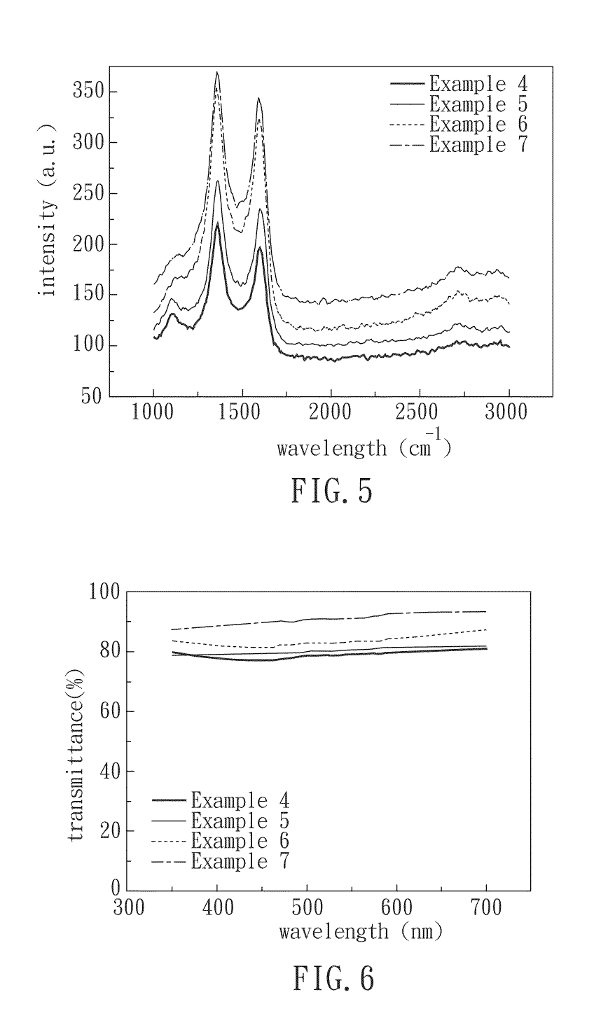

FIG. 5 shows the result of RAMAN spectrum of the graphene layers manufactured by Example 4 to Example 7, in which wavelength of 1370 cm⁻¹ is a signal peak of D-region, the wavelength of 1580 cm⁻¹ is a signal peak of G-region, and the wavelength of 2700-2800 cm⁻¹ is a signal peak of 2D-region. According to the result of D-region, G-region and 2D-region in FIG. 5, the graphene layers manufactured by Example 4 to Example 7 are multiple graphene layers. However, the graphitization degree (I_{D}/I_{G}) of the graphene layers still has to be improved. (The strengthen of G-region signal is less than D-region signal, which represents the graphitization degree of the graphene layers still has to be improved.)

In addition, according to the result of FIG. 5, the level of graphitization of the graphene layers manufactured by Example 4 to Example 7 are respectively 1.11, 1.12, 1.12 and 1.06, in which the graphene layer of Example 7 performs better level of graphitization than the others. However, the sheet resistance of each Example is around 11 kΩ (the sheet resistance of metal electrode is about 11 kΩ), in which the differences of the sheet resistance between each examples are not significant, and the reasons of that phenomenon may be related to the level of graphitization or the distance between graphene layers. Besides, according to the result of FIG. 5, the signal peaks of 2D-region from Example 4 to Example 7appear to gradually increase, indicating the number of formed graphene layers is gradually decreasing.

FIG. 6 shows a transmission spectrum of visible light of graphene layers obtained from Example 4 to Example 7, in which the observed transmittance is increased from Example 4 to Example 7. In Example 7, it is proven that high performance of 2D-region signal represents high transmittance and less number of layers of graphene.

According to the above comparison of the above examples, the different parameters may result in different quality (such as the graphitization degree and number of graphene layers) of graphene layer.

In the above examples, the provided substrate is a glass substrate; the provided metal layer is a nickel layer; and the provided carbon source layer is a PMMA layer. However, the material of the substrate may be a plastic substrate or a quartz substrate; the metal layer may be a rhodium layer; and the carbon source layer may be PDMS layer when it is necessary. The materials of the substrate, metal layer and carbon source layer are not specially limited, any of those materials known in this art also can be used in the present invention.

In conclusion, the method of the present invention can directly manufacture a graphene layer on a substrate without performing any transferring process. Benefiting from the attributes including collimation, single wavelength and energy concentration of the laser, the metal layer can be heated so that the carbon atoms can be extruded from the carbon source layer and fused into the metal layer such that after removing the laser and decreasing the temperature of the metal layer, a graphene layer can be formed on the substrate. The advantages of the method of the present invention are not only reduced production time, but also low power of the laser compared with traditional process, so as to decrease the cost for manufacturing the graphene layer. In addition, the manufacturing condition of a graphene layer in the present invention does not have to process in vacuum. The graphene layer also can be patterned without performing any transferring process to obtain a patterned graphene layer. Therefore, the present invention provides a simple and convenient method to manufacture a transparent conductive layer and applied in optoelectronic devices.

Although the present invention has been explained in relation to its preferred embodiment, it is to be understood that many other possible modifications and variations can be made without departing from the spirit and scope of the invention as hereinafter claimed.

What is claimed is:

1. A method for manufacturing a graphene layer, comprising the following steps:
providing a substrate;
forming a metal layer on a first side of the substrate;
forming a carbon source layer on the metal layer;
providing a laser, which irradiates a second side of the substrate and passes through the substrate to form a graphene layer on an interface between the substrate and the metal layer; and
providing an organic solvent and an acid solution to remove the carbon source layer and the metal layer respectively.

2. The manufacturing method as claimed in claim 1, wherein the substrate is a transparent substrate.

3. The manufacturing method as claimed in claim 1, wherein the substrate is a glass substrate, a plastic substrate or a quartz substrate.

4. The manufacturing method as claimed in claim 1, wherein the metal layer is a nickel layer or a rhodium layer.

5. The manufacturing method as claimed in claim 1, wherein a thickness of the metal layer is 10-300 nm.

6. The manufacturing method as claimed in claim 1, further comprising a step of pattering the metal layer.

7. The manufacturing method as claimed in claim 1, wherein the carbon source layer is a solid carbon source layer.

8. The manufacturing method as claimed in claim 1, wherein a material of the carbon source layer is polymethyl methacrylate (PMMA) or polydimethylsiloxane (PDMS).

9. The manufacturing method as claimed in claim 1, wherein a thickness of the carbon source layer is 100-2000 nm.

10. The manufacturing method as claimed in claim 1, wherein a wavelength of the laser is 200-2000 nm.

11. The manufacturing method as claimed in claim 1, wherein a power of the laser is 100 mW/cm²−5 W/cm².

12. The manufacturing method as claimed in claim 1, wherein an irradiation time of the laser is 0.140 minutes.

13. The manufacturing method as claimed in claim 1, wherein the organic solvent is acetone, benzene, chloroform, methyl ethyl ketone (MEK), tetrahydrofuran (THF), chclohexanone or methylene chloride.

14. The manufacturing method as claimed in claim 1, wherein the acid solution is dilute hydrochloric acid or acetic acid.
